(19) United States
(12) Patent Application Publication
(10) Pub. No.: US 2012/0320462 A1
(43) Pub. Date: Dec. 20, 2012

(54) Aimer

(75) Inventor: Chi-Hsing Lin, Taichung (TW)

(73) Assignee: ASIA OPTICAL CO., INC., Taichung (TW)

(21) Appl. No.: 13/161,312

(22) Filed: Jun. 15, 2011

(51) Int. Cl. G02B 25/00

(52) U.S. Cl. 359/643

(57) ABSTRACT

An aimer is provided. The aimer includes an object lens unit, a body and an eyepiece unit. The body is connected to the object lens unit. The eyepiece unit is connected to the body. The eyepiece unit includes a first pipe, a second pipe, a lens unit and a graduated pattern. The first pipe is connected to the body. The second pipe is connected to the first pipe, wherein the second pipe is rotated to move between a first position and a second position relative to the first pipe. The lens unit is disposed in the second pipe. The graduated pattern is formed on the second pipe.

### BACKGROUND OF THE INVENTION

1. Field of the Invention

The present invention relates to an aimer, and in particular relates to an aimer with an eyepiece unit.

2. Description of the Related Art

Conventional aimers have an object lens unit, a body and an eyepiece unit. The eyepiece unit corresponds to the object lens unit. The eyepiece unit has an outer pipe and a lens chamber. The lens chamber moves relative to the outer pipe to modify the diopter. The conventional eyepiece unit does not have a graduated pattern. Therefore, a user cannot determine the level of the diopter provided by the eyepiece unit. The lens chamber must be repeatedly moved relative to the outer pipe to reach a proper diopter level for user. Therefore, the conventional eyepiece unit design requires effort and time by users for adjustment.

### BRIEF SUMMARY OF THE INVENTION

A detailed description is given in the following embodiments with reference to the accompanying drawings.

An aimer is provided. The aimer includes an object lens unit, a body and an eyepiece unit. The body is connected to the object lens unit. The eyepiece unit is connected to the body. The eyepiece unit includes a first pipe, a second pipe, a lens unit and a graduated pattern. The first pipe is connected to the body. The second pipe is connected to the first pipe, wherein the second pipe is rotated to move between a first position and a second position relative to the first pipe. The lens unit is disposed in the second pipe. The graduated pattern is formed on the second pipe.

In one embodiment, a mark is formed on the first pipe, and a diopter level of the eyepiece unit is read from the graduated pattern corresponding to the mark.

In one embodiment, the first pipe comprises a protrusion formed on an inner wall thereof, the second pipe comprises an abutting portion and a stopping ring, the abutting portion is formed on a literal surface of the second pipe, and the stopping ring is disposed on an end of the second pipe. When the second pipe is moved to the first position relative to the first pipe, the abutting portion abuts the protrusion. When the second pipe is moved to the second position relative to the first pipe, the stopping ring abuts the protrusion.

Utilizing the aimer of the embodiment of the invention, a user can easily confirm level of the diopter provided by the eyepiece unit, and rapidly obtain a desired diopter level.

### BRIEF DESCRIPTION OF THE DRAWINGS

The present invention can be more fully understood by reading the subsequent detailed description and examples with references made to the accompanying drawings, wherein:

FIG. 1a shows an aimer of a first embodiment of the invention when a second pipe is in a first position relative to a first pipe;

FIG. 1b shows the aimer of the first embodiment of the invention when the second pipe is in a second position relative to the first pipe;

FIG. 2 shows a graduated pattern formed on a rubber ring;

FIG. 3 is a perspective view showing a portion of the aimer of the first embodiment;

FIG. 4a shows an aimer of a second embodiment of the invention;

FIG. 4b shows a graduated pattern is formed on a graduated ring; and

FIG. 5 shows an aimer of a third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

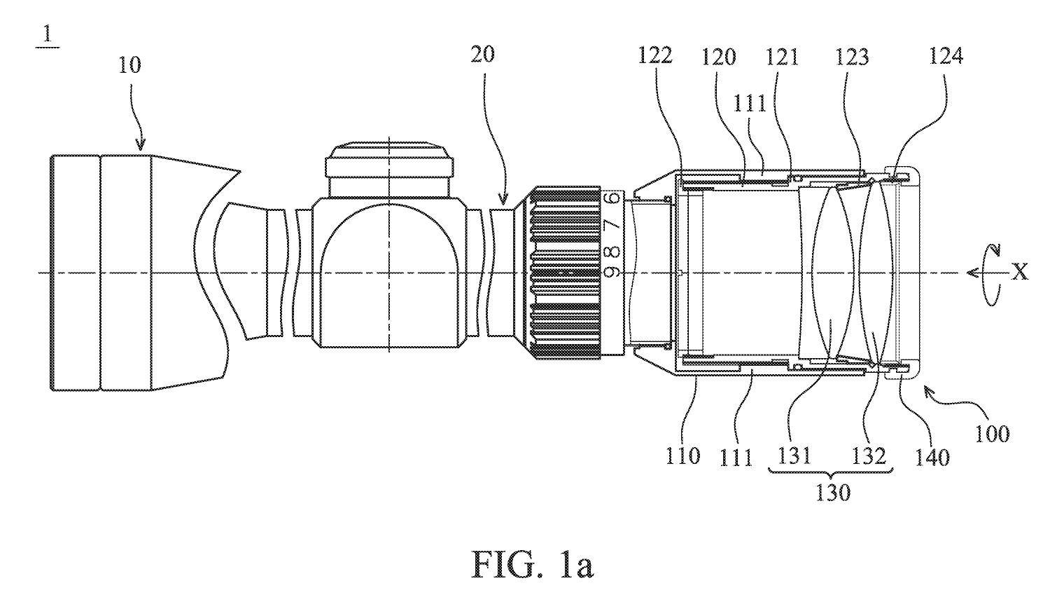

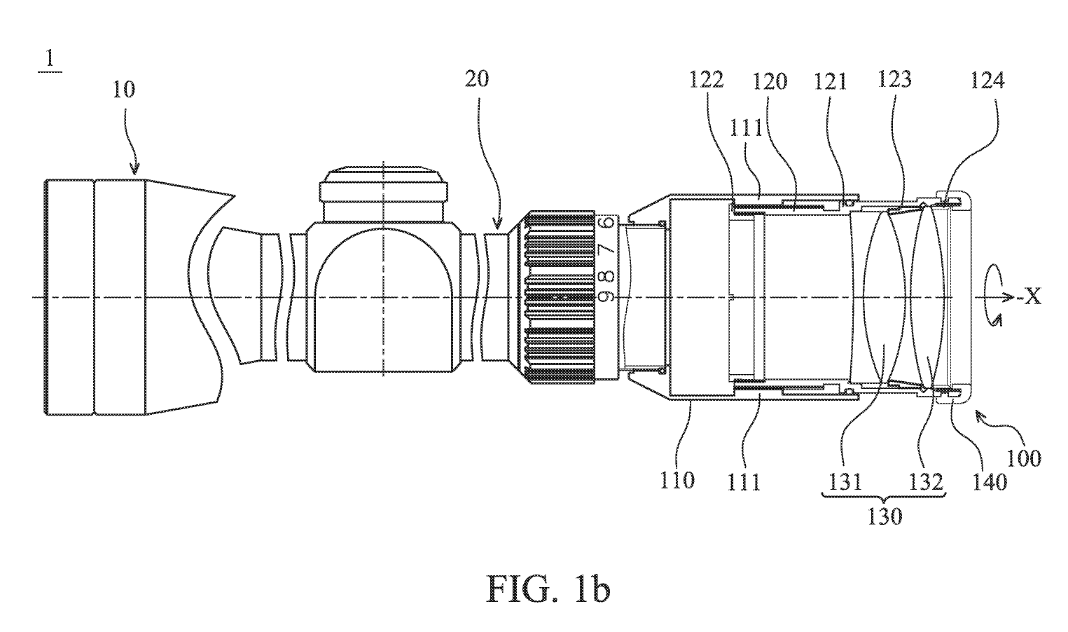

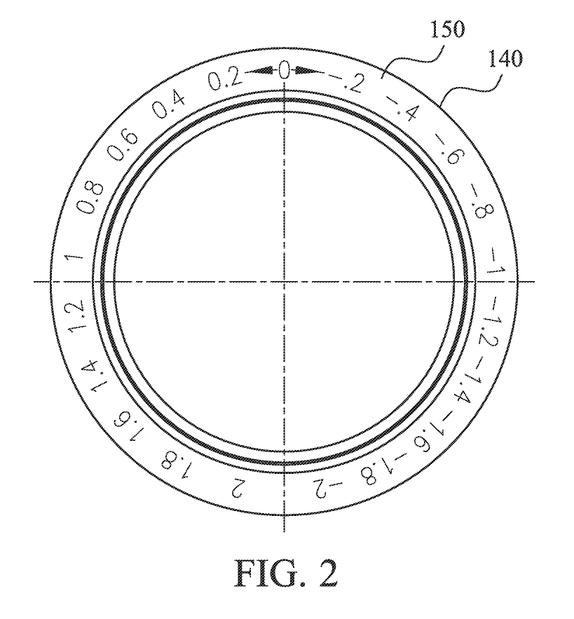

FIGS. 1a and 1b show an aimer 1 of a first embodiment of the invention. The aimer 1 includes an object lens unit 10, a body 20 and an eyepiece unit 100. The body 20 is connected to the object lens unit 10. The eyepiece unit 100 is connected to the body, and corresponds to the object lens unit 10. The eyepiece unit 100 includes a first pipe 110, a second pipe 120, a lens unit 130 and a graduated pattern (not shown). The first pipe 110 is connected to the body 20. The second pipe 120 is connected to the first pipe 110, wherein the second pipe 120 is rotated to move between a first position (as shown in Fig. la) and a second position (as shown in Fig. lb) relative to the first pipe 110, and to change the position of the eyepiece unit 100 relative to the body 20 and the object lens unit 10. A lens unit 130 is disposed in the second pipe 120. The second pipe 120 further includes a rubber ring 140 disposed on an end thereof With reference to FIG. 2, the graduated pattern 150 is formed on the rubber ring 140.

The first pipe 110 telescopes the second pipe 120. The first pipe 110 comprises a protrusion 111 formed on an inner wall thereof The second pipe 120 further comprises an abutting portion 121 and a stopping ring 122. The abutting portion 121 is formed on a literal surface of the second pipe 120. The stopping ring 122 is disposed on an end of the second pipe 120. When the second pipe 120 is rotated clockwise, the second pipe 120 is moved in a first direction (X) to the first position (as shown in Fig. la) relative to the first pipe 110, so that the abutting portion 121 abuts the protrusion 111. When the second pipe 120 is rotated counterclockwise, the second pipe 120 is moved in a second direction (-X) to the second position (as shown in Fig. lb) relative to the first pipe 110, so that the stopping ring 122 abuts the protrusion 111.

The lens unit 130 has a first lens 131 and a second lens 132, and the first lens 131 and the second lens 132 are fixed in the second pipe 120. A spacer 123 is disposed between the first lens 131 and the second lens 132. A fixing ring 124 is disposed in the second pipe 120 to fix the first lens 131, the second lens 132 and the spacer 123.

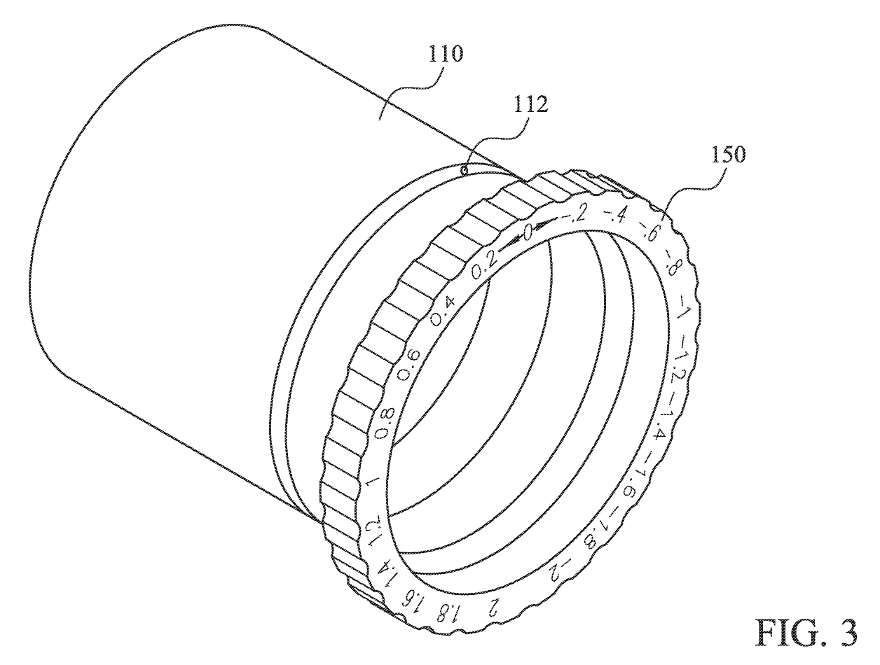

FIG. 3 is a perspective view showing a portion of the aimer 1 of the first embodiment. A mark 112 is formed on the first pipe 110, and a diopter level of the eyepiece unit is read from the graduated pattern 150 corresponding to the mark 112. With the rotation of the second pipe relative to the first pipe, the distance between the lens unit 130 and the object lens unit 10 is changed, so that the level of the diopter of the aimer 1 is changed.

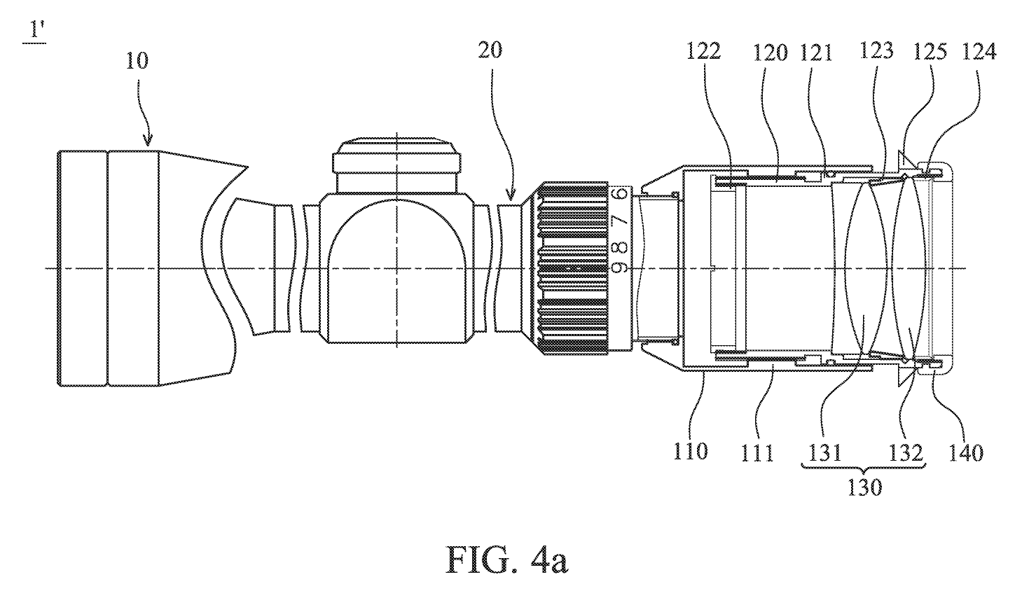

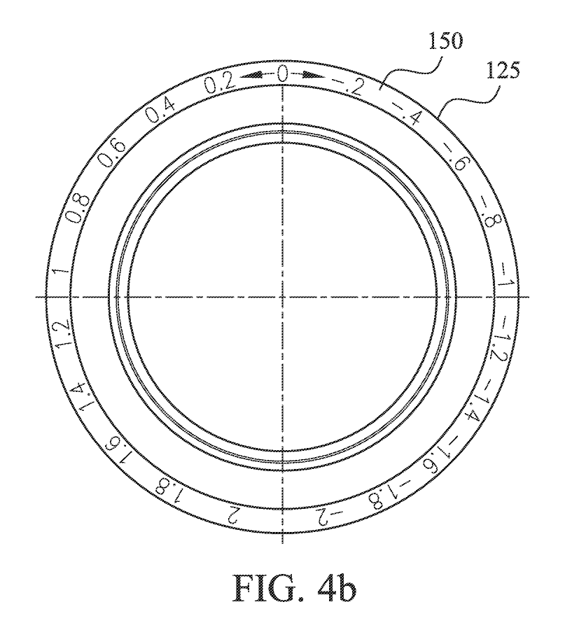

FIGS. 4a and 4b show an aimer 1′ of a second embodiment of the invention. With reference to FIG. 4a, the aimer 1′ has a graduated ring 125, the graduated pattern 150 is formed on the graduated ring 125, and the graduated ring 125 telescopes the second pipe 120.

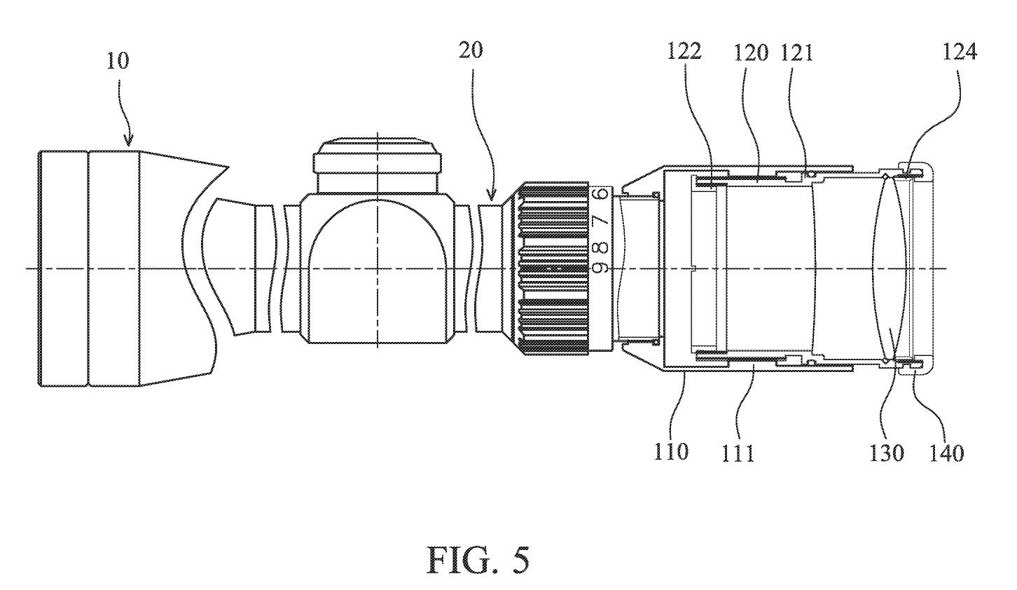

FIG. 5 shows an aimer 1″ of a third embodiment of the invention, wherein the lens unit 130′ has only one lens, and the fixing ring 124 fixes the lens (lens unit 130′) in the second pipe 120. In this embodiment, the spacer is omitted.

Utilizing the aimer of the embodiment of the invention, a user can easily confirm a level of the diopter provided by the eyepiece unit, to rapidly obtain a desired diopter level.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An aimer, comprising:
an object lens unit;
a body, connected to the object lens unit;
an eyepiece unit, connected to the body , wherein the eyepiece unit comprises:
a first pipe, connected to the body;
a second pipe, connected to the first pipe, wherein the second pipe is rotated to move between a first position and a second position relative to the first pipe;
a lens unit, disposed in the second pipe; and
a graduated pattern, formed on the second pipe.

2. The aimer as claimed in claim 1, wherein a mark is formed on the first pipe, and a diopter level of the eyepiece unit is read from the graduated pattern corresponding to the mark.

3. The aimer as claimed in claim 1, wherein the second pipe comprises a graduated ring, the graduated pattern is formed on the graduated ring, and the graduated ring telescopes the second pipe.

4. The aimer as claimed in claim 1, wherein the second pipe comprises a rubber ring, the graduated pattern is formed on the rubber ring, and the rubber ring is disposed on an end of the second pipe.

5. The aimer as claimed in claim 1, wherein the first pipe telescopes the second pipe.

6. The aimer as claimed in claim 1, wherein the lens unit has a first lens and a second lens, and the first lens and the second lens are fixed in the second pipe.

7. The aimer as claimed in claim 1, wherein the eyepiece unit further

8. The aimer as claimed in claim 7, wherein the eyepiece unit further comprises a fixing ring disposed in the second pipe to fix the first lens, the second lens and the spacer.

9. The aimer as claimed in claim 7, wherein the lens unit has a lens, and the lens is fixed in the second pipe.

10. The aimer as claimed in claim 9, wherein the eyepiece unit further comprises a fixing ring disposed in the second pipe to fix the lens.

11. The aimer as claimed in claim 1, wherein the first pipe comprises a protrusion formed on an inner wall thereof, the second pipe comprises an abutting portion and a stopping ring, the abutting portion is formed on a literal surface of the second pipe, and the stopping ring is disposed on an end of the second pipe.

12. The aimer as claimed in claim 11, wherein when the second pipe is moved to the first position relative to the first pipe, the abutting portion abuts the protrusion.

13. The aimer as claimed in claim 11, wherein when the second pipe is moved to the second position relative to the first pipe, the stopping ring abuts the protrusion.
